(19) United States
(12) Patent Application Publication
(10) Pub. No.: US 2011/0160322 A1
(43) Pub. Date: Jun. 30, 2011

(54) POROUS BONE CEMENT

(75) Inventors: Jo-Wei HUANG, Taipei (TW); Po-Yang Chen, Taipei (TW)

(73) Assignee: FAR EASTERN NEW CENTURY CORPORATION

(21) Appl. No.: 12/980,053

(22) Filed: Dec. 28, 2010

(30) Foreign Application Priority Data
Dec. 29, 2009 (TW) 098145581

(51) Int. Cl. C08K 3/32; C08L 89/00; C08L 5/00

(52) U.S. Cl. 521/84.1; 521/85

(57) ABSTRACT

The present invention provides a porous bone cement containing a powder mixture and an aqueous solution, in which the aqueous solution is water or an inorganic salt solution and the powder mixture contains:
(a) two or more bone substitution materials having different average particle sizes and independently selected from the group consisting of calcium phosphate salts, polymers and metals or salts thereof, provided that at least one of the bone substitution materials is calcium phosphate salts;
(b) calcium sulfate; and
(c) a bioresorbable molecule which is soluble in the aqueous solution and has higher biological resorption or degradation rate than calcium sulfate.
   The porous bone cement of the present invention is applicable in treating dental and bone defects and in plastic surgery. By mixing two or more bone substitution materials having different average particle sizes and two biomaterials having different biological resorption or degradation rates, the present invention provides a bone cement with suitable mechanical strength and porosity after hardened.

### BACKGROUND OF THE INVENTION

1. Field of the Invention

The present invention relates to a novel porous bone cement applicable in treating dental and bone defects and in plastic surgery.

2. Description of the Prior Art

Bone cement materials are mainly used in treating bone defects in organisms, and can support the injured portion after administration so as to prevent secondary injuries. Generally speaking, a bone cement contains a powder mixture composed of bone substitution materials and an aqueous solution for mixing with the powder mixture to form a fluid before use. The fluid should be easy to use, and must be hardened within a short period of time after implantation in order to avoid being damaged by body fluid. After the bone cement is hardened, the mechanical strength must be sufficient to support the injured portion in order to prevent secondary injuries.

Since the mechanical strength of the bone cement material must be maintained, the importance of porosity is rarely emphasized. With a porous bone cement material, the rough external surface allows cells to easily adhere thereto, and internal pores provide space for cells to grow. However, the pores may impair the mechanical strength of the bone cement material after hardened, so it is necessary to develop a bone cement material having suitable strength and porosity.

Substances commonly used as bone substitution material in the bone cement include polymers, metals or salts; for example, in U.S. Pat. No. 4,141,864, polymethyl methacrylate is used as the main material. However, polymethyl methacrylate is not a normal component of bone, has a poorer biocompatibility than natural components, and produces an exothermic reaction during hardening, which easily affects the tissues around the injured portion. Therefore, later, a bone cement was developed by using components similar to those of bone. For example, in U.S. Pat. No. 7,351,280, hydroxyapatite (one of important components of bone), tricalcium phosphate and tetracalcium phosphate are used as main components, and growth factors are added to facilitate bone growth. In U.S. Pat. No. 6,955,716, dicalcium phosphate and tricalcium phosphate, which gradually form hydroxyapatite after mixing in vivo, are used as main components. However, the bone cement materials disclosed in the patents have low hardening rates, and are easily damaged by body fluid after use, thus losing the strength and failing to serve their functions. Therefore, U.S. Pat. Nos. 7,417,077 and 7,393,405 further disclose adding calcium sulfate to facilitate hardening. However, since calcium sulfate cannot be biologically resorbed or degraded at an early stage after the implantation of the bone cement to provide porosity in the material, bone cells cannot easily adhere to the bone cement, resulting in reduction in the therapeutic efficacy. As described above, the porous bone cement material should allow cells to easily adhere thereto and grow, thus promoting the generation of intercellular substances, thereby improving the therapeutic efficacy.

Porosity can be increased by many methods, for example, in U.S. Pat. Nos. 4,296,209 and 6,547,866, pores are formed by adding a component that can easily produce bubbles, such as sodium carbonate. However, trace gas in organism causes physical discomfort for patients or causes a change in PH.

U.S. Pat. Nos. 4,093,576 and 6,955,716 disclose adding biologically dissolvable substances to a bone cement material, so that the porosity of the bone cement material can be increased after the substances are biologically dissolved. However, the average particle size of the bone substitution material is not described in further detail in the above two patents. If only a small-particle bone substitution material is used, as shown in FIG. 1, the interparticle spacing is small, so the bone cement material has a compact structure after hardened; when the substances are dissolved, no obvious pores can be formed due to the excessively compact structure, and thus cells cannot grow smoothly in the pores. On the other hand, if only a large-particle bone substitution material is used, as shown in FIG. 2, the interparticle spacing is too large, so the bone cement material has a loose structure after hardened; although pores can be formed for cell growth when the substances are dissolved, this will lead to a significant impairment of the mechanical strength, and even structural collapse. Therefore, it is necessary to develop a bone cement material having suitable mechanical strength and porosity.

### SUMMARY OF THE INVENTION

Accordingly, the present invention is directed to a porous bone cement containing a powder mixture and an aqueous solution, in which the aqueous solution is water or an inorganic salt solution and the powder mixture contains:

(a) two or more bone substitution materials having different average particle sizes and independently selected from the group consisting of calcium phosphate salts, polymers and metals or salts thereof, provided that at least one of the bone substitution materials is calcium phosphate salts;

(b) calcium sulfate; and

(c) a bioresorbable molecule which is soluble in the aqueous solution and has higher biological resorption or degradation rate than calcium sulfate.

### BRIEF DESCRIPTION OF THE DRAWINGS

FIG. 1 is a schematic view showing the situation where only a small-particle bone substitution material is used.

FIG. 2 is a schematic view showing the situation where only a large-particle bone substitution material is used.

FIG. 3 is a schematic view showing the situation where two bone substitution materials having different average particle sizes are used according to the present invention.

FIG. 4 is a picture of a cylindrical sample formed in Example 1 after immersion in water.

FIG. 5 is a picture of a cylindrical sample formed in Comparative Example 1 after immersion in water.

FIG. 6 is a picture of a cylindrical sample formed in Comparative Example 3 after immersion in water.

### DETAILED DESCRIPTION

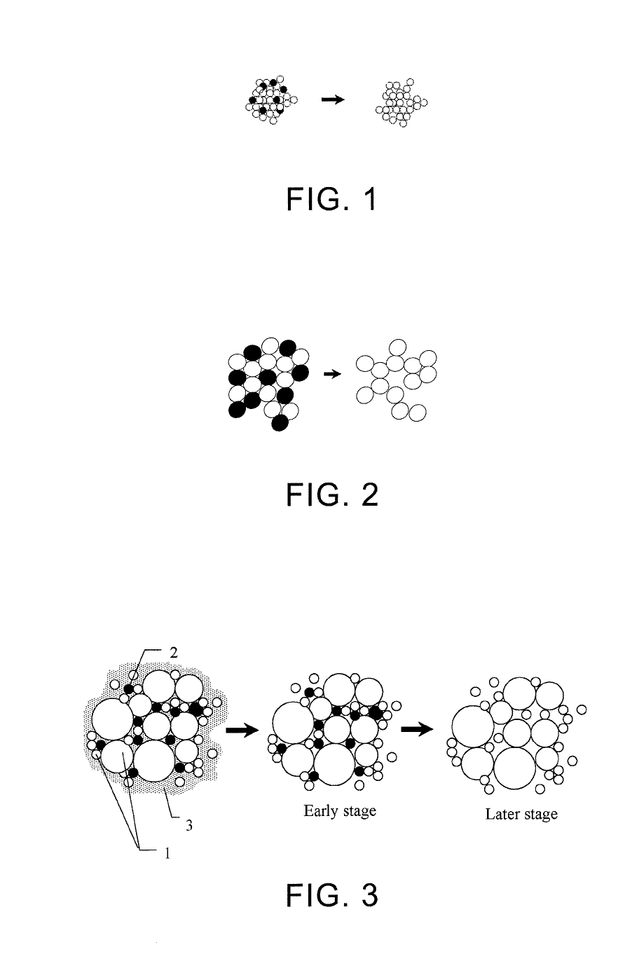

Generally speaking, a bone cement mainly contains a powder mixture and an aqueous solution, and the powder mixture and the aqueous solution form the bone cement after being hardened by hydration. The aqueous solution is water or an inorganic salt solution, and the powder mixture can be a bone substitution material. If only a small-particle bone substitution material is used in the powder mixture, the bone cement material has a compact structure after hardened, so when certain substances are dissolved, it is difficult to form open pores, as shown in FIG. 1. On the other hand, if only a large-particle bone substitution material is used in the powder mixture, the bone cement material has a loose structure after hardened, so when certain substances are dissolved, obvious pores are formed, which will lead to an impairment of the mechanical strength, as shown in FIG. 2. Therefore, the present invention is mainly to provide a bone cement material having suitable porosity and mechanical strength through two technical means. First, two or more bone substitution materials having different average particle sizes are used to provide suitable porosity and mechanical strength of the bone cement structure after hardened. Second, two or more bioresorbable substances having different biological resorption or degradation rates are added to control the formation of pores, so as to facilitate cell adhesion and growth.

As shown in FIG. 3, the present invention uses two or more bone substitution materials (1) which have different average particle sizes and are unbiodegradable as the main body, into which calcium sulfate (2) and a bioresorbable molecule (3) which is soluble in the aqueous solution and has a higher biological resorption or degradation rate than calcium sulfate are blended to control the formation of pores and cell adhesion. When the substances are hardened by hydration, the stacked structure of large particles can increase the porosity, and the small particles dispersed between the pores can provide the mechanical strength. In addition, after being dissolved in the aqueous solution, the bioresorbable molecule easily forms a continuous phase between the particles, and the continuous phase can reduce the occurrence of cracking between the particles, thereby improving the overall mechanical properties.

Meanwhile, since calcium sulfate (2) and the bioresorbable molecule (3) have different biological resorption or degradation rates, specifically, calcium sulfate (2) cannot be biologically degraded until several months while the bioresorbable molecule (3) can be biologically degraded within several days, this increases the surface roughness of the pores formed by the degradation and dissolution of the bioresorbable molecule (3) at an early stage, thus facilitating cell adhesion, and open pores can be further formed continuously after the degradation and resorption of calcium sulfate (2) in vivo at a later stage, to provide sufficient space for the growth of cells in the bone cement structure. Thus, a slow forming process of the pores can achieve suitable mechanical strength, so that the formation of pores will not cause any impairment of the mechanical strength.

According to the present invention, the bone substitution materials contained in the powder mixture of the porous bone cement is present in an amount of 7 wt % to 80 wt %, preferably 10 wt % to 65 wt %, and more preferably 20 wt % to 35 wt %, based on the total weight of the powder mixture. In addition, since excessively small pores inhibit the inward growth of cells, and excessively large pores lead to an impairment of the mechanical strength, the powder mixture preferably contains at least a small-particle bone substitution material having an average particle size of 0.1 μm to 50 μm and a large-particle bone substitution material having an average particle size of 150 μm to 300 μm. The small-particle bone substitution material is present in an amount of 30 wt % to 90 wt %, and the large-particle bone substitution material is present in an amount of 10 wt % to 70 wt %, based on the total weight of the bone substitution materials in the powder mixture.

According to an embodiment of the present invention, two bone substitution materials having different average particle sizes are used in the powder mixture of the porous bone cement, and the small-particle bone substitution material and the large-particle bone substitution material are each present in an amount of 50 wt %, based on the total weight of the bone substitution materials in the powder mixture.

According to the present invention, materials useful in the powder mixture of the porous bone cement of the present invention as the bone substitution materials include calcium phosphate salts, polymers and metals or salts thereof. Since human bone contains large amounts of phosphorus and calcium, preferably, at least one of the two or more bone substitution materials having different average particle sizes contained in the powder mixture is calcium phosphate salts, and more preferably, the two or more bone substitution materials having different average particle sizes are all calcium phosphate salts.

The calcium phosphate salts useful in the present invention as the bone substitution materials include, but are not limited to, calcium phosphate, dicalcium phosphate, tricalcium phosphate, tetracalcium phosphate, octacalcium phosphate, hydroxyapatite or combinations thereof, and are preferably hydroxyapatite.

The polymers useful in the present invention as the bone substitution materials include, but are not limited to, polylactic acid, polymethyl methacrylate, polyglycolic acid, polyethylene glycol, polycaprolactone, polyvinyl alcohol, polyacrylic acid, copolymers thereof or combinations thereof.

The metals or salts thereof useful in the present invention as the bone substitution materials include, but are not limited to, aluminum, alumina, titanium and titania.

According to the present invention, the powder mixture of the porous bone cement further contains calcium sulfate, which is present in an amount of 10 wt % to 90 wt %, preferably 20 wt % to 70 wt %, and more preferably 50 wt % to 65 wt %, based on the total weight of the powder mixture.

Calcium sulfate, commonly referred to as gypsum, includes anhydrous calcium sulfate (CaSO4), calcium sulfate hemihydrate (CaSO4.1/2H2O) and calcium sulfate dihydrate (CaSO4.2H20). Calcium sulfate hemihydrate is added into the powder mixture of the porous bone cement of the present invention, and becomes calcium sulfate dihydrate after being mixed with the aqueous solution to yield water for hydration, thereby facilitating hardening of the bone cement. Moreover, since calcium sulfate will be degraded in vivo within several months, open pores are formed after the degradation of calcium sulfate, to provide sufficient space for the growth of cells in the bone cement structure. According to an embodiment of the present invention, calcium sulfate preferably has an average particle size of 30 μm to 80 μm, and most preferably has an average particle size of 40 μm.

According to the present invention, the powder mixture of the porous bone cement further contains bioresorbable molecule which is soluble in the aqueous solution, and the bioresorbable molecule is present in an amount of 3 wt % to 30 wt %, and preferably 15 wt % to 25 wt %, based on the total weight of the powder mixture. The bioresorbable molecule useful in the present invention has higher biological resorption or degradation rate than calcium sulfate. Generally speaking, the bioresorbable molecule can be biologically degraded within several days, so that surface pores are formed at an early stage after the implantation of the bone cement, thereby facilitating cell adhesion. In addition, the dissolved substances must have good biocompatibility, in order to avoid inflammation or discomfort due to the change in the local environment. The bioresorbable molecule useful in the present invention includes, but is not limited to, saccharides and derivatives thereof, amino acids and copolymers thereof, proteins, inorganic salts, polymers, greases or combinations thereof. The saccharides and derivatives thereof include, but are not limited to, proteoglycan, glycoprotein, glucosamine, starch, hyaluronic acid, glucose, chitin derivatives, cellulose, gelatin, alginate, pectin, chondroitin sulfate, salts thereof or combinations thereof.

Depending upon practical applications, the powder mixture of the porous bone cement of the present invention can further contain one or more other additives that are known to persons of ordinary skill in the art and have no adverse effect on the constituents of the present invention, such as fluorides and antibiotics.

According to the present invention, the aqueous solution useful in the porous bone cement of the present invention contains water or an inorganic salt solution, and after the aqueous solution is mixed with the powder mixture, the bone cement can be hardened by hydration at room temperature. In practical applications, such as those in treating dental and bone defects and in plastic surgery, first, the powder mixture is mixed with the aqueous solution and stirred; then, the formulated bone cement is applied to an organism by using a syringe or other conventional injection methods.

The following embodiments are used to further describe the present invention, and do not limit the scope of the present invention. Any modifications and variations that can be easily made by persons of ordinary skill in the art shall fall within the disclosure of this specification and the scope of the appended claims.

### EXAMPLES

### Preparation of the Bone Cement

### Example 1

0.719 g of hydroxyapatite powder having an average particle size of 20 μm and 0.719 g of hydroxyapatite powder having an average particle size of 251 μm were taken respectively, into which 3.625 g of calcium sulfate having an average particle size of 40 μm was added, and 1.112 g of glucosamine was mixed. After being mixed uniformly, 1.28 ml of simulated human body fluid was added, and after being stirred uniformly, the resultant mixture was hardened in 12 min.

### Example 2

2.4 g of tricalcium phosphate having an average particle size of 40 μm and 5.6 g of hydroxyapatite powder having an average particle size of 251 μm were taken, into which 1.0 g of calcium sulfate having an average particle size of 40 μm was added, and 1.0 g of glucosamine was mixed. After being mixed uniformly, 2.23 ml of simulated human body fluid were added, and after being stirred uniformly, the resultant mixture was hardened in 24 min.

### Example 3

0.35 g of hydroxyapatite powder having an average particle size of 20 μm and 0.35 g of hydroxyapatite powder having an average particle size of 251 μm were taken respectively, into which 9.0 g of calcium sulfate having an average particle size of 40 μm were added, and 0.3 g of glucosamine was mixed. After being mixed uniformly, 2.59 ml of simulated human body fluid were added, and after being stirred uniformly, the resultant mixture was hardened in 7 min.

### Example 4

1.8 g of hydroxyapatite powder having an average particle size of 50 μm and 0.2 g of hydroxyapatite powder having an average particle size of 300 μm were taken respectively, into which 5.0 g of calcium sulfate having an average particle size of 40 μm were added, and 3.0 g of glucosamine were mixed. After being mixed uniformly, 1.68 ml of simulated human body fluid was added, and after being stirred uniformly, the resultant mixture was hardened in 16 min.

### Example 5

0.575 g of hydroxyapatite powder having an average particle size of 20 μm and 0.863 g of hydroxyapatite powder having an average particle size of 251 μm were taken respectively, into which 3.625 g of calcium sulfate having an average particle size of 40 μm were added, and 0.2 g of hyaluronic acid powder was mixed. After being mixed uniformly, 1.1 ml of simulated human body fluid was added, and after being stirred uniformly, the resultant mixture was hardened in 18 min.

### Comparative Example 1

The same raw materials and preparation procedures as Example 1 were used, except that no glucosamine was added.

### Comparative Example 2

1.4375 g of hydroxyapatite powder having an average particle size of 251 μm was taken directly, into which 3.625 g of calcium sulfate having an average particle size of 40 μm was added, and 1.112 g of glucosamine was mixed. After being mixed uniformly, 1.28 ml of simulated human body fluid was added, and after being stirred uniformly, the resultant mixture was hardened in 15 min.

### Comparative Example 3

1.4375 g of hydroxyapatite powder having an average particle size of 20 μm was taken directly, into which 3.625 g of calcium sulfate having an average particle size of 40 μm were added, and 1.112 g of glucosamine was mixed. After being mixed uniformly, 1.28 ml of simulated human body fluid was added, and after being stirred uniformly, the resultant mixture was hardened in 13 min.

Strength Test

Before being hardened, the samples of Examples 1 to 5 and

Comparative Examples 2 and 3 were respectively placed in a cylindrical mold having a radius of 6 mm and a height of 12 mm, and placed at 37° C. for 24 hr and then taken out. The compression stresses of the obtained cylinders were respectively measured with Istron before and after immersion in water (shaken in water for 6 hr), with the compression rate being 1 mm/min. The measurement results are shown in Table 1.

TABLE 1

| | | |
|---|---|---|
| Example 1 | before immersion in water | 42.28 MPa |
| | after immersion in water | 35.13 MPa |
| Example 2 | before immersion in water | 39.67 MPa |
| | after immersion in water | 33.50 MPa |
| Example 3 | before immersion in water | 45.23 MPa |
| | after immersion in water | 41.92 MPa |
| Example 4 | before immersion in water | 43.55 MPa |
| | after immersion in water | 30.71 MPa |
| Example 5 | before immersion in water | 34.80 MPa |
| | after immersion in water | 29.63 MPa |
| Comparative Example 2 | before immersion in water | 33.80 MPa |
| | after immersion in water | 19.25 MPa |
| Comparative Example 3 | before immersion in water | 43.32 MPa |
| | after immersion in water | 40.54 MPa |

As can be seen from Table 1, the cylindrical samples formed in Examples 1 to 5 still had sufficient strength, though the material strength was impaired by surface pores formed due to the dissolution of the biodegradable molecule after immersion in water. It can be seen by comparing the data of Example 1 and Comparative Example 2 that, after immersion in water, the mechanical strength of the bone cement sample formed by only using hydroxyapatite having a large average particle size (Comparative Example 2) was significantly decreased, and the mechanical strength of the bone cement sample formed by using hydroxyapatite having different average particle sizes in Example 1 was significantly increased. In addition, it can be found by comparing the data of Example 1 and Comparative Example 3 that, although the bone cement sample formed by only using hydroxyapatite having a small average particle size (Comparative Example 3) before immersion in water and the bone cement sample of Example 1 had similar mechanical strength, the change in the strength of the former was small after immersion in water, which indicates that the bone cement sample of Comparative Example 3 had poor porosity, which is not conducive to the smooth growth of cells therein after implantation into an organism.

Surface Pore Test

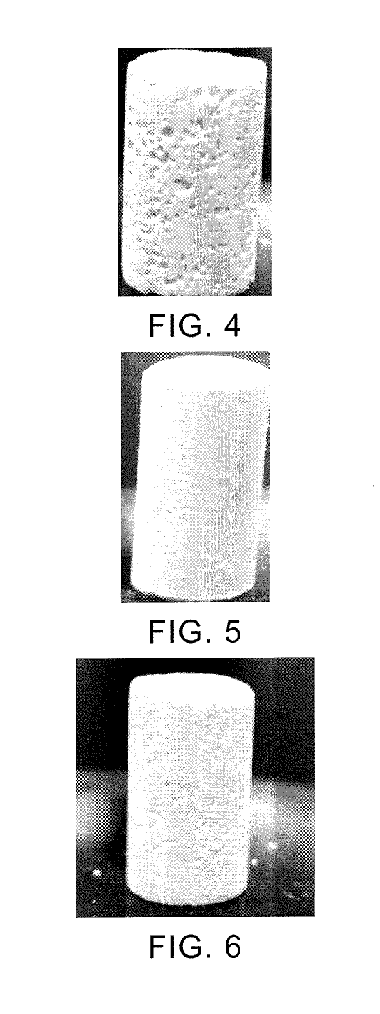

The cylindrical samples formed in Example 1, Comparative Example 1 and Comparative Example 3 were shaken in water for 6 hr, and the roughness of external surfaces of the cylinders was observed, with the results sequentially shown in FIGS. 4 to 6. It can be found that the surface of the cylindrical sample formed in Example 1 (FIG. 4) had obvious pores and thus sufficient surface roughness for cell adhesion. As shown in FIGS. 5 and 6, no obvious pores were formed on the external surfaces of the cylindrical samples formed in Comparative Example 1 (without glucosamine added) and Comparative Example 3 (with only hydroxyapatite having a small average particle size added) after immersion in water, and thus the surface roughness was insufficient, which would make it difficult for cells to adhere to the cylindrical samples.

It will be appreciated that various improvements of the present invention are feasible and can be easily thought of and anticipated by persons skilled in the art.

1. A porous bone cement comprising a powder mixture and an aqueous solution, wherein the aqueous solution is water or an inorganic salt solution and the powder mixture comprises:
(a) two or more bone substitution materials having different average particle sizes independently selected from the group consisting of calcium phosphate salts, polymers and metals or salts thereof, provided that at least one of the bone substitution materials is a calcium phosphate salt;
(b) calcium sulfate; and
(c) a bioresorbable molecule which is soluble in the aqueous solution and has a higher biological resorption or degradation rate than calcium sulfate.

2. The porous bone cement according to claim 1, wherein the bone substitution materials are present in an amount of 7 wt % to 80 wt %, based on the total weight of the powder mixture.

3. The porous bone cement according to claim 2, wherein the bone substitution materials are present in an amount of 10 wt % to 65 wt %, based on the total weight of the powder mixture.

4. The porous bone cement according to claim 3, wherein the bone substitution materials are present in an amount of 20 wt % to 35 wt %, based on the total weight of the powder mixture.

5. The porous bone cement according claim 1, comprising at least a small-particle bone substitution material having an average particle size of 0.1 μm to 50 μm and a large-particle bone substitution material having an average particle size of 150 μm to 300 μm.

6. The porous bone cement according to claim 5, wherein the small-particle bone substitution material is present in an amount of 30 wt % to 90 wt %, based on the total weight of the bone substitution materials in the powder mixture.

7. The porous bone cement according to claim 5, wherein the large-particle bone substitution material is present in an amount of 10 wt % to 70 wt %, based on the total weight of the bone substitution materials in the powder mixture.

8. The porous bone cement according to claim 5, wherein the small-particle bone substitution material and the large-particle bone substitution material are phosphate salts selected from the group consisting of calcium phosphate, dicalcium phosphate, tricalcium phosphate, tetracalcium phosphate, octacalcium phosphate, hydroxyapatite and combinations thereof.

9. The porous bone cement according to claim 5, wherein the bone substitution materials contained in the powder mixture are composed of the two bone substitution materials having different average particle sizes, and the small-particle bone substitution material and the large-particle bone substitution material are each present in an amount of 50 wt %, based on the total weight of the bone substitution materials in the powder mixture.

10. The porous bone cement according to claim 9, wherein the small-particle bone substitution material and the large-particle bone substitution material are phosphate salts selected from the group consisting of calcium phosphate, dicalcium phosphate, tricalcium phosphate, tetracalcium phosphate, octacalcium phosphate, hydroxyapatite and combinations thereof.

11. The porous bone cement according to claim 1, wherein the phosphate salts are selected from the group consisting of calcium phosphate, dicalcium phosphate, tricalcium phosphate, tetracalcium phosphate, octacalcium phosphate, hydroxyapatite and combinations thereof.

12. The porous bone cement according to claim 1, wherein the polymers are selected from the group consisting of polylactic acid, polymethyl methacrylate, polyglycolic acid, polyethylene glycol, polycaprolactone, polyvinyl alcohol, polyacrylic acid, copolymers thereof and combinations thereof.

13. The porous bone cement according to claim 1, wherein calcium sulfate is present in an amount of 10 wt % to 90 wt %, based on the total weight of the powder mixture.

14. The porous bone cement according to claim 13, wherein calcium sulfate is present in an amount of 20 wt % to 70 wt %, based on the total weight of the powder mixture.

15. The porous bone cement according to claim 13, wherein calcium sulfate is present in an amount of 50 wt % to 65 wt %, based on the total weight of the powder mixture.

16. The porous bone cement according to claim 13, wherein calcium sulfate has an average particle size of 30 μm to 80 μm.

17. The porous bone cement according to claim 16, wherein calcium sulfate has an average particle size of 40 μm.

18. The porous bone cement according to claim 1, wherein the bioresorbable molecule is present in an amount of 3 wt % to 30 wt %, based on the total weight of the powder mixture.

19. The porous bone cement according to claim 18, wherein the bioresorbable molecule is present in an amount of 15 wt % to 25 wt %, based on the total weight of the powder mixture.

20. The porous bone cement according to claim 18, wherein the bioresorbable molecule is selected from the group consisting of saccharides and derivatives thereof, amino acids and copolymers thereof, proteins, inorganic salts, polymers, greases and combinations thereof.

21. The porous bone cement according to claim 20, wherein the saccharides and derivatives thereof are selected from the group consisting of proteoglycan, glycoprotein, glucosamine, starch, hyaluronic acid, glucose, chitin derivatives, cellulose, gelatin, alginate, pectin, chondroitin sulfate, salts thereof and combinations thereof.
